(19) United States
(12) Patent Application Publication
(10) Pub. No.: US 2015/0287056 A1
(43) Pub. Date: Oct. 8, 2015

(54) PROCESSING APPARATUS, PROCESSING METHOD, AND PROGRAM

(71) Applicant: INTERNATIONAL BUSINESS MACHINES CORPORATION, Armonk, NY (US)

(72) Inventors: Takayuki Osogami, Kanagawa (JP); Makoto Otsuka, Okinawa (JP)

(21) Appl. No.: 14/743,408

(22) Filed: Jun. 18, 2015

Related U.S. Application Data
(63) Continuation of application No. 14/564,937, filed on Dec. 9, 2014.

(30) Foreign Application Priority Data
Dec. 13, 2013 (JP) 2013-258421

(51) Int. Cl. G06Q 30/02; G06N 7/00; G06F 17/16; G06Q 10/06; G06N 99/00

(52) U.S. Cl. CPC G06Q 30/0201; G06Q 10/067; G06N 99/005; G06F 17/16; G06N 7/005

(57) ABSTRACT

A processing apparatus, a processing method, and a program that generates a selection model obtained by modeling selection behavior of a target to a given choice. The processing apparatus includes an acquiring unit configured to acquire learning data including at least one selection behavior for learning in which choices given to the target are input choices and choices selected out of the input choices are output choices, an input vector generating unit configured to generate an input vector that indicates whether each of a plurality of kinds of choices is included in the input choices, and a learning processing unit configured to learn the selection model using the input vector corresponding to an input choice for learning and the output choices.

### RELATED APPLICATION DATA

This application is a Continuation application of co-pending U.S. patent application Ser. No. 14/564,937 filed on Dec. 9, 2014, which claims priority under 35 U.S.C. §119 from Japanese Patent Application No. 2013-258421 filed Dec. 13, 2013, both of which are incorporated herein by reference in their entirety.

### BACKGROUND

1. Technical Field

The present invention relates to a processing apparatus, a processing method, and a program.

2. Description of the Related Art

A method of analyzing consumption behavior of consumers, a system for recommending commodities to consumers, and the like have been known (see, for example, Non-Patent Literatures 1 to 3). In addition, it is known that, when a consumer selects one commodity out of a plurality of commodities, selection behavior of the consumer is variously cognitively biased.

### PATENT LITERATURE

(Non-Patent Literature 1) Roe, Robert M.; Busemeyer, Jermone R.; Townsend, James T.; “Multichoice decision field theory: A dynamic connectionst model of decision making.”, Psychological Review, Vol. 108(2), April 2001, 370-392.

(Non-Patent Literature 2) Hruschka, Harald.; “Analyzing market baskets by restricted Boltzmann machines.”, OR Spectrum, August 2012, 1-20.

(Non-Patent Literature 3) Teppan, Erich Christian; Alexander Felfernig; “Minimization of product utility estimation errors in recommender result set evaluations, “Proceedings of the 2009 IEEE/WIC/ACM International Joint Conference on Web Intelligence and Intelligent Agent Technology-Volume 01. IEEE Computer Society, 2009.

### SUMMARY

Cognitively-biased selection behavior of the consumer affects relative selection probabilities of commodities according to the kinds of items included in a commodity list of choices. It is difficult to represent the selection behavior using a known model. Even if the cognitive biases are modeled, the model is complicated. Further, it is not known that even a learning algorithm is built.

In a first aspect of the present invention, a processing apparatus, a processing method, and a program generates a selection model obtained by modeling selection behavior of a target to a given choice. The processing apparatus includes: an acquiring unit configured to acquire learning data including at least one selection behavior for learning in which choices given to the target are input choices and choices selected out of the input choices are output choices, an input vector generating unit configured to generate an input vector that indicates whether each of a plurality of kinds of choices is included in the input choices, and a learning processing unit configured to learn the selection model using the input vector corresponding to an input choice for learning and the output choices.

According to another aspect of the invention, a processing method for generating a selection model obtained by modeling selection behavior of a target to a given choice is provided, the processing method comprising: an acquiring step for acquiring learning data including at least one selection behavior for learning in which choices given to the target are input choices and choices selected out of the input choices are output choices, an input vector generating step for generating an input vector that indicates whether each of a plurality of kinds of choices is included in the input choices, and a learning processing step for learning the selection model using the input vector corresponding to an input choice for learning and the output choices.

A still further aspect of the invention provides a computer program which, when executed, cause a computer to act as the processing apparatus or to perform the steps of the above method.

Note that the summary of invention does not enumerate all features of the present invention. Sub-combinations of these feature groups could be inventions.

### BRIEF DESCRIPTION OF THE DRAWINGS

FIG. 1 illustrates a first example of a cognitive bias according to an illustrative embodiment;

FIG. 2 illustrates a second example of the cognitive bias according to an illustrative embodiment;

FIG. 3 illustrates a third example of the cognitive bias according to an illustrative embodiment;

FIG. 4 illustrates a configuration example of a processing apparatus 100 according to an illustrative embodiment;

FIG. 5 illustrates an operation flow of the processing apparatus 100 according to an illustrative embodiment;

FIG. 6 illustrates an example of learning data according to an illustrative embodiment;

FIG. 7 illustrates an example of a selection model according to an illustrative embodiment;

FIG. 8 illustrates an example of probabilities that choices calculated by a probability calculating unit 160 according to an illustrative embodiment are selected;

FIG. 9 illustrates a first modification of the processing apparatus 100 according to an illustrative embodiment;

FIG. 10 illustrates a modification of a selection model 10 according to an illustrative embodiment;

FIG. 11 illustrates a second modification of the processing apparatus 100 according to an illustrative embodiment;

FIG. 12 illustrates an example of probabilities that choices output by the second modifications of the processing apparatus 100 according to an illustrative embodiment are selected; and

FIG. 13 is an example of a hardware configuration of a computer 1900 functioning as the processing apparatus 100 according to an illustrative embodiment.

### DETAILED DESCRIPTION OF THE PREFERRED EMBODIMENTS

The present invention is explained below with reference to an embodiment of the invention. However, the embodiment does not limit inventions according to the scope of claims. All combinations of features explained in the embodiment are not always essential to the solution of the invention.

It is known that, in the behavior of targets, such as a person and an animal, presented with choices to select any one of the choices on the basis of preferences and the like, selection results of the selection behavior change according to the given choices. In this embodiment, as an example of such selection behavior, selection behavior of a consumer to select one commodity out of a plurality of commodities is explained.

When a consumer selects one commodity out of a plurality of commodities, selection behavior of the consumer is variously cognitively biased. For example, when a plurality of commodities including a first commodity and a second commodity are presented to the consumer as choices, a ratio of probabilities that the respective first and second commodities are selected by the consumer is sometimes different according to the other commodities included in the presented choices. In this case, the presence of the other commodities included in the presented choices cognitively biases the selection behavior of the consumer.

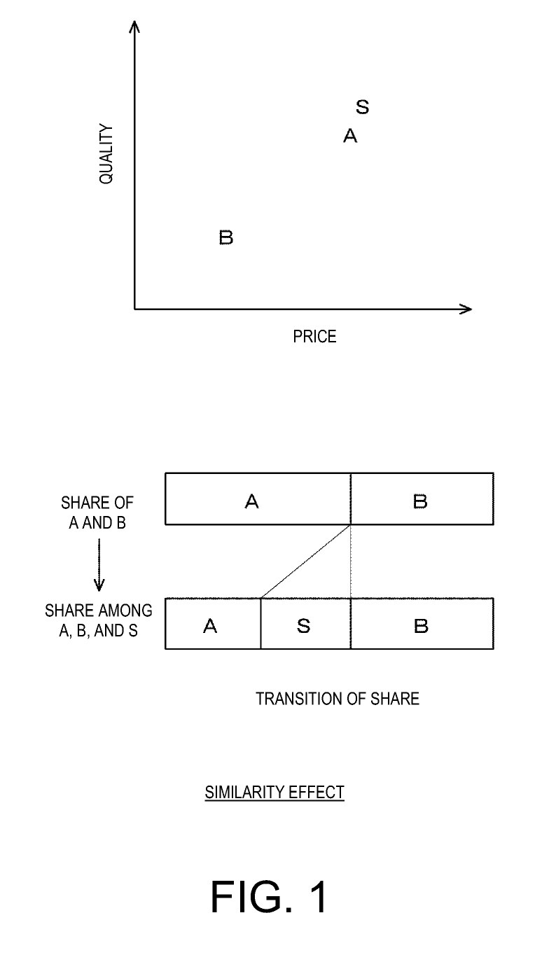

FIG. 1 illustrates a first example of a cognitive bias according to an illustrative embodiment. FIG. 1 is a diagram for explaining a similarity effect, which is the cognitive bias in this embodiment. In FIG. 1, commodities A, B, and S are choices presented to the consumer. In a graph of FIG. 1, as an example of characteristics of the commodities, a price is plotted on the abscissa and the commodities A, B, and S are plotted on the ordinate as quality. That is, the commodity A is a commodity having a higher price and higher quality compared with the commodity B. The commodity S is a commodity similar to the commodity having a higher price and higher quality compared with the commodity B.

First, when there are choices of the commodity A and the commodity B in the market, shares of the commodities A and B are determined according to probabilities that the respective commodities A and B are selected by the consumer. When the commodity S is added to the market, since the commodity S is similar to the commodity A, the share of the commodity A is sometimes reduced to change a ratio of the shares of the commodities A and B. That is, in this case, with respect to the choices of the commodities A and B, the presence of the commodity S similar to the commodity A cognitively biases the selection behavior of the consumer such that the share of the commodity A is divided by the commodities A and S. Such an effect of the cognitive bias is called the similarity effect.

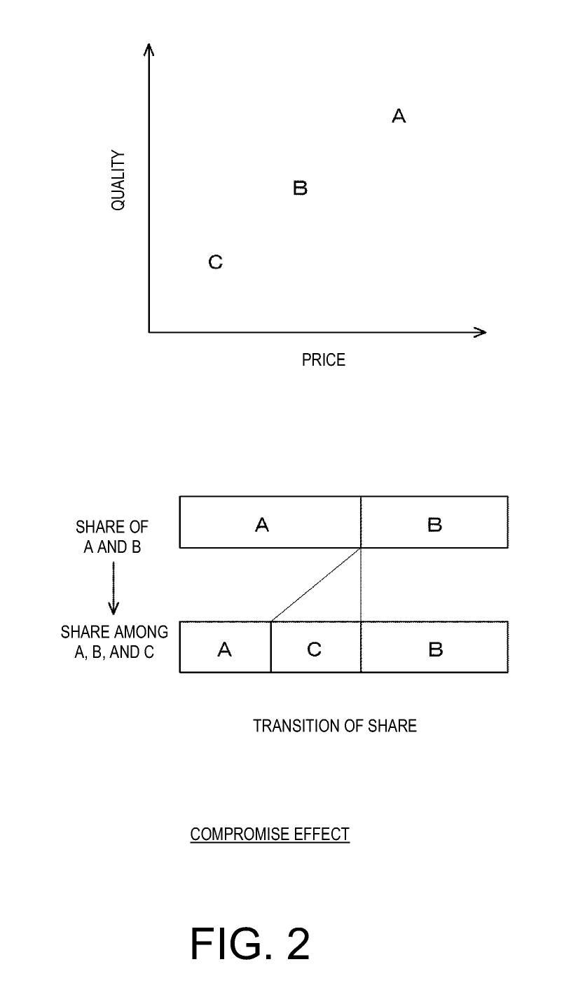

FIG. 2 illustrates a second example of the cognitive bias according to an illustrative embodiment. FIG. 2 is a diagram for explaining a compromise effect, which is the cognitive bias in this embodiment. In FIG. 2, commodities A, B, and C are choices presented to the consumer. In a graph of FIG. 2, as in FIG. 1, as an example of characteristics of the commodities, a price is plotted on the abscissa and the commodities A, B, and C are plotted on the ordinate as quality. That is, the commodity A is a commodity having a higher price and higher quality compared with the commodity B. The commodity C is a commodity having a lower price and lower quality compared with the commodity B.

First, when there are choices of the commodity A and the commodity B in the market, shares of the commodities A and B are determined according to probabilities that the respective commodities A and B are selected by the consumer. When the commodity C is added to the market, prices and degrees of quality of the commodities A, B, and C are arranged in this order. The share of the commodity A having the higher price and the higher quality is sometimes reduced to change a ratio of the shares of the commodities A and B.

For example, with respect to the choices of the commodities A and B, the presence of the commodity C inferior to the commodity B in both the price and the quality forms ranks of balances of the prices and the quality of the commodities. The share of the commodity A having the higher price and the higher quality is divided by the commodity A and the commodity C. As a result, the share of the commodity B, having the intermediate price and the intermediate quality, is improved. Such an effect of cognitively biasing the selection behavior of the consumer with the commodity C is called the compromise effect.

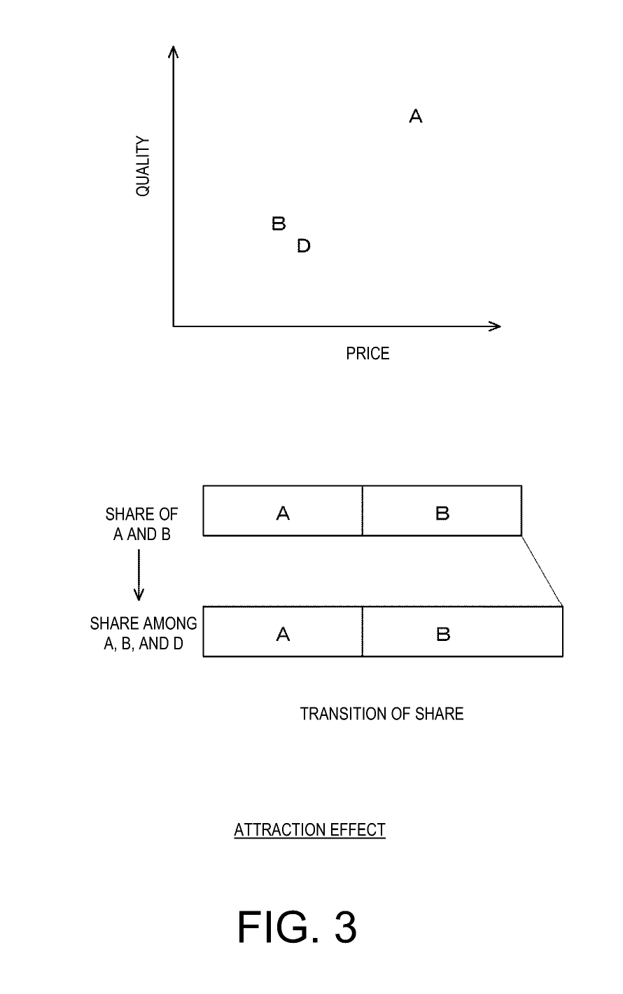

FIG. 3 illustrates a third example of the cognitive bias according to an illustrative embodiment. FIG. 3 is a diagram for explaining an attraction effect, which is the cognitive bias in this embodiment. In FIG. 3, commodities A, B, and D are choices presented to the consumer. In a graph of FIG. 3, as in FIG. 1, as an example of characteristics of the commodities, a price is plotted on the abscissa and the commodities A, B, and D are plotted on the ordinate as quality. That is, the commodity A is a commodity having a higher price and higher quality compared with the commodity B. The commodity D is a commodity having a slightly higher price and slightly lower quality compared with the commodity B.

First, when there are choices of the commodity A and the commodity B in the market, shares of the commodities A and B are determined according to probabilities that the respective commodities A and B are selected by the consumer. When the commodity D is added to the market, since the commodity B relatively has a lower price and higher quality than the commodity D, the share of the commodity B is sometimes increased to change a ratio of the shares of the commodities A and B.

That is, in this case, with respect to the choices of the commodities A and B, the presence of the commodity D, having a higher price and slightly inferior quality to the commodity B, cognitively biases the selection behavior of the consumer such that a preferable impression is given to the price and the quality of the commodity B. Such an effect of the cognitive bias is called the attraction effect.

As illustrated in the three examples explained above, the selection behavior of the consumer in the market is variously cognitively biased. As a result, the shares and the like of the commodities are determined. Therefore, for example, when consumption behavior of the consumer is analyzed and when commodities are recommended to the consumer, it is desirable to use a model that takes into account the cognitive biases. However, it is difficult to represent the consumption behavior using a conventional learning model. Even if the cognitive biases are modeled, the model is complicated. The model cannot be learned.

Therefore, a processing apparatus 100 in this embodiment represents, as a learnable model, selection behavior of a consumer cognitively biased by formularizing the selection behavior as a problem for learning mapping to an output vector that indicates a selection item selected out of input vectors that indicate choices given to the consumer and the like. That is, the processing apparatus 100 generates a selection model obtained by modeling selection behavior of a target with respect to given choices.

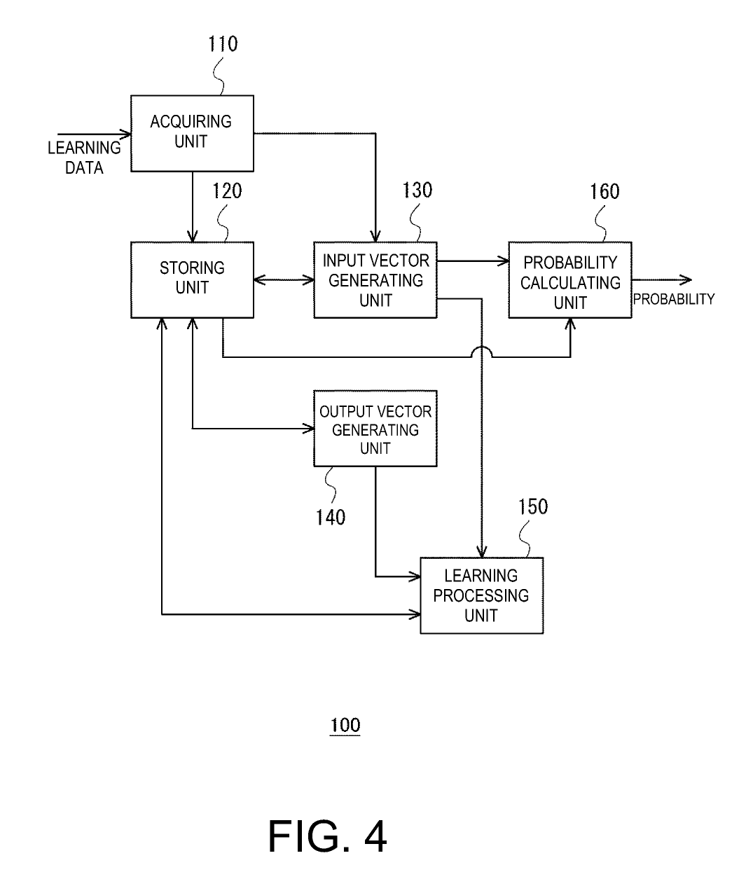

FIG. 4 illustrates an example configuration of the processing apparatus 100 according to this embodiment. The processing apparatus 100 includes an acquiring unit 110, a storing unit 120, an input vector generating unit 130, an output vector generating unit 140, a learning processing unit 150, and a probability calculating unit 160.

The acquiring unit 110 receives, as input choices, choices given to a target and acquires learning data including at least one kind of selection behavior for learning for setting choices selected out of the input choices as output choices. The acquiring unit 110 acquires, as learning data, for example, data of input choices given to a consumer among a plurality of commodities and data of a commodity selected by the consumer. The acquiring unit 110 may acquire learning data according to an input of a user. Alternatively, the acquiring unit 110 may read out and acquire data stored in a predetermined format.

The acquiring unit 110 may be connected to a network or the like and acquire learning data in a position different from a main body of the processing apparatus 100 and supply the acquired learning data to a main body unit via the network. For example, the acquiring unit 110 accesses a server or the like and acquires learning data stored on the server. The acquiring unit 110 may acquire, as learning data, information such as choices of commodities given to the consumer and a history of commodities purchased or placed a cart or the like by the consumer from an Electronic Commerce (EC) site or the like that sells commodities, services, and the like on a web site.

The acquiring unit 110 may be realized by another device and perform acquisition of learning data as pre-processing of the main body of the processing apparatus 100. As an example, the acquiring unit 110 supplies the acquired learning data to the storing unit 120.

The storing unit 120 is connected to the acquiring unit 110 and stores the learning data received from the acquiring unit 110. The storing unit 120 stores a selection model generated by the processing apparatus 100. The storing unit 120 may store data and the like processed in a process for generating the selection model. The storing unit 120 may supply the stored data to request sources according to requests from the units in the processing apparatus 100.

The input vector generating unit 130 generates an input vector that indicates whether each of a plurality of kinds of choices is included in input choices. The input vector generating unit 130 is connected to the storing unit 120 and generates an input vector from the acquired learning data. The input vector generating unit 130 supplies the generated vector to the learning processing unit 150.

The output vector generating unit 140 generates an output vector that indicates whether each of a plurality of kinds of choices is included in output choices for learning. The output vector generating unit 140 is connected to the storing unit 120 and generates an output vector from the acquired learning data. The output vector generating unit 140 supplies the generated output vector to the storing unit 120 and the learning processing unit 150.

The learning processing unit 150 is connected to the input vector generating unit 130 and the output vector generating unit 140 and learns the selection model using the received input vector and output vector for learning. The learning processing unit 150 learns the selection model including selection behavior corresponding to a cognitive bias of a target. That is, the learning processing unit 150 learns the selection model using parameters including a bias parameter, a value of which is determined according to choices given to the consumer. The learning processing unit 150 is connected to the storing unit 120 and stores the learned selection model, the determined parameter, and the like in the storing unit 120.

The probability calculating unit 160 calculates probabilities, on the basis of the learned selection model, the determined parameters, and the like, that the respective choices are selected according to input choices. The probability calculating unit 160 is connected to the storing unit 120 and reads out the learned selection model, the determined parameters, and the like from the storing unit 120. The probability calculating unit 160 is connected to the input vector generating unit 130 and receives the input vector generated by the input vector generating unit 130.

The probability calculating unit 160 calculates a probability that a choice corresponding to the input vector is selected. In this case, the acquiring unit 110 may acquire information concerning the choice, for which the probability should be calculated, from the user and supply the information to the probability calculating unit 160 via the input vector generating unit 130. When the processing apparatus 100 is a learning apparatus used for learning processing of a selection model, the probability calculating unit 160 used for prediction does not have to be provided.

The processing apparatus 100 in this embodiment learns mapping from the input vector to the output vector using the parameters including the bias parameter and generates a selection model obtained by modeling the selection behavior of the consumer to the given choices. A specific operation of the processing apparatus 100 is explained below.

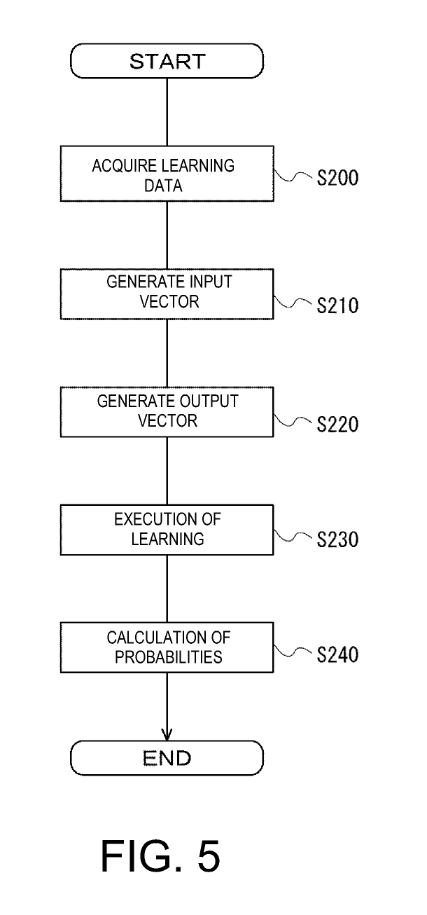

FIG. 5 illustrates an operation flow of the processing apparatus 100 according to this embodiment. The processing apparatus 100 in this embodiment executes the operation flow shown in FIG. 5, learns a selection model, and calculates a probability corresponding to a learning result.

First, the acquiring unit 110 acquires learning data (S200). The acquiring unit 110 acquires information concerning J commodities, which are likely to be presented to the consumer, presented choices (e.g., a plurality of commodities selected out of the J commodities), commodities selected out of the choices by the consumer, and the like. In this embodiment, as an example, the acquiring unit 110 acquires five commodities (A, B, C, D, and S) as the commodities likely to be presented to the consumer.

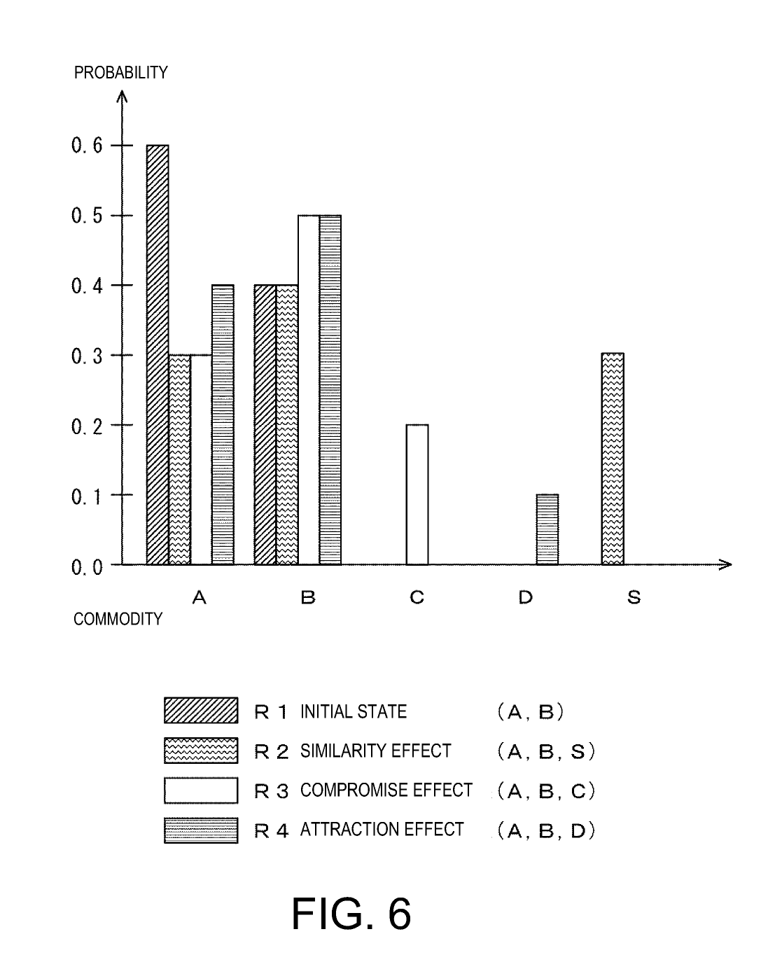

FIG. 6 illustrates an example of learning data according to this embodiment. The abscissa of FIG. 6 indicates commodities likely to be presented to the consumer and the ordinate indicates probabilities that the commodities are selected by the consumer. FIG. 6 illustrates a selection result obtained when four kinds of choices are presented to the consumer.

For example, in FIG. 6, bar graphs corresponding to R1, indicated by hatching, are present in the commodities A and B. The bar graph of the commodity A indicates 0.6. The bar graph of the commodity B indicates 0.4. The commodity A is a commodity having a higher price and higher quality compared with the commodity B.

That is, R1 is a choice for presenting the commodities A and B to the consumer and indicates that a result is obtained in which a probability that the commodity A is selected by the consumer is 60% and a probability that the commodity B is selected by the consumer is 40%. It is assumed that shares of the commodities A and B in the market are substantially the same percentages as the probabilities of selection by the consumer. In this embodiment, the choice R1 and the result obtained by presenting the choice R1 are learning data in an “initial state” for causing the consumer to select a commodity first.

In FIG. 6, bar graphs corresponding to R2, indicated by wavy lines, are present in the commodities A, B, and S. The bar graph of the commodity A indicates 0.3, the bar graph of the commodity B indicates 0.4, and the bar graph of the commodity S indicates 0.3. Consequently, R2 is a choice for presenting the commodities A, B, and S to the consumer and indicates that a result is obtained in which a probability that the commodity A is selected by the consumer is 30%, a probability that the commodity B is selected by the consumer is 40%, and a probability that the commodity S is selected by the consumer is 30%.

The commodity S of the choice R2 is a commodity similar to the commodity A in performance, a price, quality, and the like. When the choice R2 is presented (the commodity S is added) after the choice R1 (the commodities A and B) is presented to the consumer and shares of the commodities A and B are determined, the share 60% of the commodity A, which is a result obtained by presenting the choice R1, changes to be divided by the commodities A and S similar to each other (in this example, the commodity A is 30% and the commodity S is 30%). That is, in this embodiment, the choice R2 and the result obtained by presenting the choice R2 are learning data indicating a “similarity effect”.

In FIG. 6, bar graphs corresponding to R3, indicated by a blank fill, are present in the commodities A, B, and C. The bar graph of the commodity A indicates 0.3, the bar graph of the commodity B indicates 0.5, and the bar graph of the commodity C indicates 0.2. Consequently, R3 is a choice for presenting the commodities A, B, and C to the consumer and indicates that a result is obtained in which a probability that the commodity A is selected by the consumer is 30%, a probability that the commodity B is selected by the user is 50%, and a probability that the commodity C is selected by the user is 20%.

The commodity C of the choice R3 is a commodity having a lower price and lower quality compared with the commodity B. When the choice R3 is presented (the commodity C is added) after the choice R1 (the commodities A and B) is presented to the consumer and shares of the commodities A and B are determined, the share of 60% of the commodity A, which is a result obtained by presenting the choice R1, is reduced. As a result, a share of the commodity B having an intermediate price and intermediate quality is improved (in this example, the commodity A is 30% and the commodity B is 50%). That is, in this embodiment, the choice R3 and the result obtained by presenting the choice R3 are learning data indicating a “compromise effect”.

In FIG. 6, bar graphs corresponding to R4 are present in the commodities A, B, and D. The bar graph of the commodity A indicates 0.4, the bar graph of the commodity B indicates 0.5, and the bar graph of the commodity D indicates 0.1. Consequently, R4 is a choice for presenting the commodities A, B, and D to the consumer and indicates that a result is obtained in which a probability that the commodity A is selected by the consumer is 40%, a probability that the commodity B is selected by the consumer is 50%, and a probability that the commodity D is selected by the consumer is 10%.

The commodity D of the choice R4 is a commodity having a slightly higher price and slightly lower quality compared with the commodity B. When the choice R4 is presented (the commodity D is added) after the choice R1 (the commodities A and B) is presented to the consumer and shares of the commodities A and B are determined, since the commodity B relatively has a lower price and higher quality than the commodity D, the share of the commodity B is increased (in this example, the share of the commodity B increases from 40% to 50%). That is, in this embodiment, the choice R4 and the result obtained by presenting the choice R4 are learning data indicating an “attraction effect”.

The acquiring unit 110 acquires the learning data explained above and stores the learning data in the storing unit 120. Instead of this or in addition to this, the acquiring unit 110 may supply the acquired learning data to the input vector generating unit 130 and the output vector generating unit 140.

The input vector generating unit 130 generates an input vector (S210). The input vector generating unit 130 sets, as an input vector x, for example, a vector including a plurality of choices (commodities) x_{J} as elements in which a choice xᵢ given to the consumer is set to a nonzero value (e.g., 1) and a choice not given to the consumer is set to 0 (J is a total number of possible choices and is a natural number equal to or larger than 2). That is, the input vector generating unit 130 generates the input vector x including an element xᵢ indicated by the following expression:

xᵢε {0,1}, iε {1, . . . , J} (Expression 1)

As an example, the input vector generating unit 130 generates an input vector x=(x₁, x₂, x₃, x₄, x₅) corresponding to the five commodities (A, B, C, D, and S) according to the learning data shown in FIG. 6. Here, x₁ corresponds to the commodity A, x₂ corresponds to the commodity B, x₃ corresponds to the commodity C, x₄ corresponds to the commodity D, and x₅ corresponds to the commodity S. Since the choice R1 of the learning data in the initial state is the choice for presenting the commodities A and B, the input vector generating unit 130 sets x^{R1}=(1, 1, 0, 0, 0). Similarly, the input vector generating unit 130 generates input vectors corresponding to the choices R1 to R4 as indicated by the following expression. Note that a vector notation is omitted in “x” on the left side.

x^{R1}=(1, 1, 0, 0, 0)

x^{R2}=(1, 1, 0, 0, 1)

x^{R3}=(1, 1, 1, 0, 0)

x^{R4}=(1, 1, 0, 1, 0) (Expression 2)

Subsequently, the output vector generating unit 140 generates an output vector (S220). The output vector generating unit 140 sets, as an output vector y, for example, a vector including a plurality of choices (commodities) y_{J} as elements in which a choice yᵢ selected by the consumer is set to a nonzero value (e.g., 1) and the other elements are set to 0). That is, the output vector generating unit 140 generates the output vector y including an element yᵢ indicated by the following expression:

yⱼε {0, 1}, jε {1, . . . , J} (Expression 3)

As an example, the output vector generating unit 140 generates an output vector y=(y₁, y₂, y₃, y₄, y₅) corresponding to the five commodities (A, B, C, D, and S) according to the learning data shown in FIG. 6. Here, y₁ corresponds to the commodity A, y₂ corresponds to the commodity B, y₃ corresponds to the commodity C, y₄ corresponds to the commodity D, and y₅ corresponds to the commodity S. When the consumer selects the commodity A with respect to the choice R1 of the learning data in the initial state, the output vector generating unit 140 sets an output vector as y^{R1A}=(1, 0, 0, 0, 0).

Similarly, when the consumer selects the commodity B, the output vector generating unit 140 sets an output vector as y^{R1B}=(0, 1, 0, 0, 0). The output vector generating unit 140 generates output vectors indicated by the following expression to correspond to the choices R1 to R4:

y^{R1A}=(1, 0, 0, 0, 0)

y^{R1B}=(0, 1, 0, 0, 0)

y^{R2A}=(1, 0, 0, 0, 0)

y^{R2B}=(0, 1, 0, 0, 0)

y^{R2S}=(0, 0, 0, 0, 1)

y^{R3A}=(1, 0, 0, 0, 0)

y^{R3B}=(0, 1, 0, 0, 0)

y^{R3C}=(0, 0, 1, 0, 0)

y^{R4A}=(1, 0, 0, 0, 0)

y^{R4B}=(0, 1, 0, 0, 0)

y^{R4D}=(0, 0, 0, 1, 0) (Expression 4)

Subsequently, the learning processing unit 150 executes learning of a selection model using the input vector and the output vector for learning (S230). In the learning data in this embodiment, for example, a ratio (0.6/0.4) of selection probabilities of the commodity A and the commodity B in the initial state changes to a different ratio (0.3/0.4) according to a result of the similarity effect. Similarly, the ratio changes to different ratios according to choices, for example, the ratio (0.3/0.5) by a result of the compromise effect and the ratio (0.4/0.5) by a result of the attraction effect.

It has been difficult to model selection behavior in which a ratio of selection probabilities of commodities included in the choice changes according to a choice presented to the consumer. Therefore, the learning processing unit 150 in this embodiment formularizes the selection behavior of the consumer as a problem for learning mapping from an input vector to an output vector and learns a selection model in which a ratio of selection probabilities of choices included in input choices is variable depending on a combination of the other choices included in the input choices.

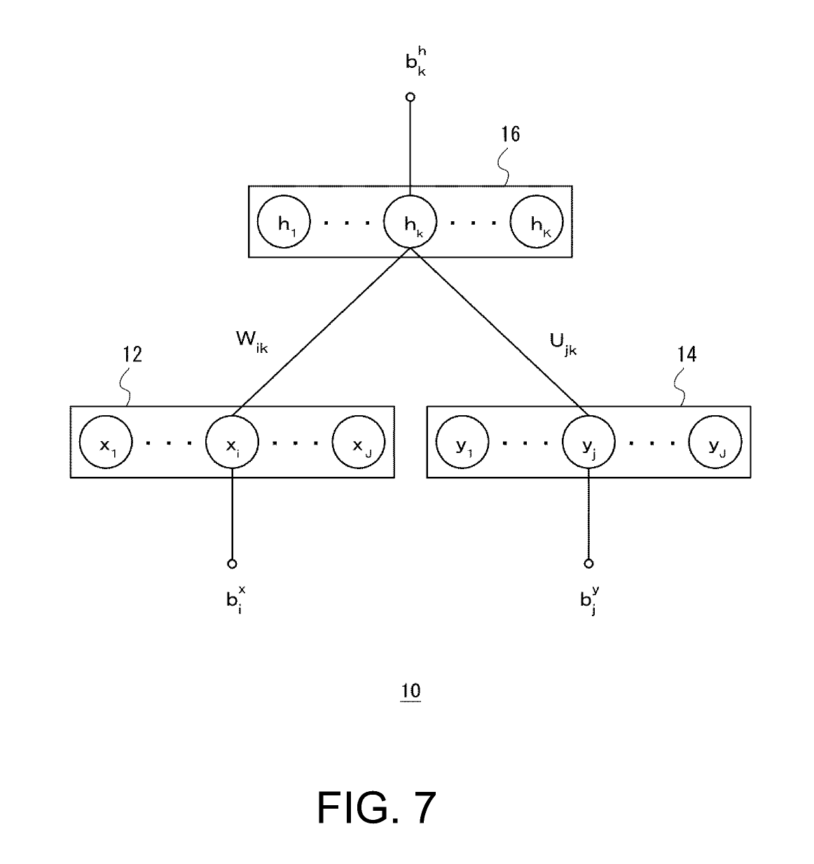

FIG. 7 illustrates an example of a selection model 10 according to an illustrative embodiment. The selection model 10 includes an input layer 12, an output layer 14, and an intermediate layer 16. The input layer 12 includes each of a plurality of kinds of choices as an input node. That is, input nodes correspond to elements of an input vector. Values of the nodes are substantially the same as values of the elements of the input vector. For example, the input layer 12 includes x₁, x₂, x₃, x₄, and x₅ as input nodes to correspond to the input vector x=(x₁, x₂, x₃, x₄, x₅).

The output layer 14 includes each of a plurality of kinds of choices as an output node. That is, output nodes correspond to elements of an output vector. Values of the nodes are substantially the same as values of the elements of the output vector. For example, the output layer 14 includes y₁, y₂, y₃, y₄, and y₅ as output nodes to correspond to the input vector y=(y₁, y₂, y₃, y₄, y₅).

The intermediate layer 16 includes a plurality of intermediate nodes. The number K of intermediate nodes hₖ is a natural number equal to or larger than 1 and may be the same as the number J of the input nodes (the number of output nodes). As an example, a value of the intermediate node hₖ is a nonzero value (e.g., 1) or 0. The intermediate layer 16 is a hidden layer used to represent input and output characteristics of a selection model. As the value of the intermediate node hₖ included in the intermediate layer 16, the value of 1 or 0 does not have to be uniquely calculated as a result. For example, a distribution of probabilities having the value 1 or 0 may be obtained. The value of the intermediate node hₖ is indicated by the following expression:

hₖε {0, 1}, kε {1, . . . , K} (Expression 5)

Complexity of input and output characteristics, which the selection model 10 can represent, can be increased or reduced according to the number K of intermediate nodes. Therefore, to increase characteristics desired to be represented, it is preferable to increase the number K of intermediate nodes. On the other hand, a computational amount necessary for learning of the selection model 10 increases according to the increase in the number K of intermediate nodes. Therefore, to execute the learning at a higher speed, it is preferable to reduce the number K of intermediate nodes. Taking this into account, a user or the like of the processing apparatus 100 may set the number K of intermediate nodes to a predetermined proper value. In this embodiment, an example is explained in which the number K of the intermediate nodes hₖ is the same as the number J of input nodes (=5).

In the selection model 10, first weight values Wᵢₖ are set between the input nodes xᵢ and the intermediate nodes hₖ. That is, the input nodes xᵢ and the intermediate nodes hₖ are respectively connected. The first weights Wᵢₖ are respectively added to the flow of data by the connection. In the selection model 10, second weight values Uⱼₖ are set between the intermediate nodes hₖ and the output nodes yⱼ. That is, the intermediate nodes hₖ and the output nodes yⱼ are respectively connected. The second weights Uᵢₖ are respectively added to the flow of data by the connection.

The first weights Wᵢₖ and the second weights Uⱼₖ are symmetrical weights for adding a fixed weight to the flow irrespective of the direction of the flow of the data. The nodes in the layers are not connected to one another. The input nodes xᵢ and the output nodes yⱼ do not have to be connected to each other. In this embodiment, an example is explained in which the input nodes xᵢ and the output nodes yⱼ are not connected.

In the selection model 10, input biases, intermediate biases, and output biases are further set for the nodes included in the input layer 12, the intermediate layer 16, and the output layer 14. That is, input biases bᵢ^{x} are respectively set for the input nodes xᵢ of the input layer 12. Similarly, output biases bⱼ^{y} are respectively set for the output nodes yⱼ of the output layer 14. Intermediate biases bₖ^{h} are respectively set for the intermediate nodes hₖ of the intermediate layer 16.

The learning processing unit 150 learns the first weights Wᵢₖ between the input nodes xᵢ and the intermediate nodes hₖ and the second weight values Uⱼₖ between the intermediate nodes hₖ and the output nodes yⱼ. The learning processing unit 150 further learns the input biases bᵢ^{x} of the input layer 12, the intermediate biases bₖ^{h} of the intermediate layer 16, and the output biases bⱼ^{y} of the output layer 14. That is, the learning processing unit 150 learns the first weight values Wᵢₖ, the second weight values Uⱼₖ, the input biases bᵢ^{x}, the intermediate biases bₖ^{h}, and the output biases bⱼ^{y} as parameters. As an example, the learning processing unit 150 sets the parameters as elements of a vector θ and learns the parameters using the parameter vector θ (Wᵢₖ, Uⱼₖ, bᵢ^{x}, bₖ^{h}, bⱼ^{y}).

For example, the learning processing unit 150 learns a selection model based on a Restricted Boltzmann Machine. The Boltzmann Machine is a system that is configured by probabilistic elements, which operate probabilistically, outputs various values according to probabilities even if being caused to operate with a fixed input, and obtains appearance probabilities (appearance frequencies) of the outputs from observation system rows (e.g., time system rows) of the outputs. When each of the probabilistic elements are settled in a probabilistic equilibrium state, that is, when an appearance probability of a state of each of the probabilistic elements is substantially fixed, an appearance probability of a state α is proportional to a Boltzmann distribution (exp{−E(α)/T}).

That is, although an output itself of the Boltzmann Machine temporally fluctuates, the appearance probability is uniquely determined from an input and is temporally substantially fixed. Note that the Boltzmann Machine sometimes causes, according to an initial value, a transitional period in which the appearance probability temporally fluctuates. However, by causing the Boltzmann Machine to operate for a sufficiently long time until the influence of the initial value decreases, the appearance probability converges to a temporally substantially fixed value. In this embodiment, an example is explained in which the selection model is learned on the basis of such a system of the Boltzmann Machine.

The learning processing unit 150 generates an input and output sample vector s^{1m}=(x¹, y^{m}) (or an input and output sample row, an input and output sample array, etc.) including elements of an input vector and an output vector. The learning processing unit 150 may generate input and output sample vectors by a number corresponding to a selection probability, which is a selection result by the consumer.

For example, when a result of selection of the commodity A by the consumer responding to the presentation of the choice R1 in the initial state is 60%, the learning processing unit 150 generates six input and output sample vectors s^{R1A} corresponding to the result. In this case, when a result of selection of the commodity B responding to the presentation of the choice R1 is 40%, the learning processing unit 150 generates four input and output sample vectors s^{R1B} corresponding to the result. As an example, the learning processing unit 150 generates the input and output sample vector s^{1m} as indicated by the following expression. Note that, in the following expression, the numbers of vectors generated by the learning processing unit 150 are also shown.

s^{R1A}=(1, 1, 0, 0, 0, 1, 0, 0, 0, 0): six

s^{R1B}=(1, 1, 0, 0, 0, 0, 1, 0, 0, 0): four

s^{R2A}=(1, 1, 0, 0, 1, 1, 0, 0, 0, 0): three

s^{R2B}=(1, 1, 0, 0, 1, 0, 1, 0, 0, 0): four

s^{R2S}=(1, 1, 0, 0, 1, 0, 0, 0, 0, 1): three

s^{R3A}=(1, 1, 1, 0, 0, 1, 0, 0, 0, 0): three

s^{R3B}=(1, 1, 1, 0, 0, 0, 1, 0, 0, 0): five

s^{R3C}=(1, 1, 1, 0, 0, 0, 0, 1, 0, 0): two

s^{R4A}=(1, 1, 0, 1, 0, 1, 0, 0, 0, 0): four

s^{R4B}=(1, 1, 0, 1, 0, 0, 1, 0, 0, 0): five

s^{R4D}=(1, 1, 0, 1, 0, 0, 0, 0, 1, 0): one (Expression 6)

The learning processing unit 150 learns the selection model 10 using forty input and output sample vectors in total shown in Expression (6) as samples for learning. The learning processing unit 150 may use, as the samples for learning, data set obtained by shuffling the forty input and output sample vectors in total at random.

The learning processing unit 150 updates the parameter vector θ such that at least one of p(y, x) and p(y|x) is higher for each of the input and output sample vectors. Here, p(y, x) indicates a simultaneous probability that an input vector is x and an output vector is y. Further, p(y|x) indicates a conditional probability that the output vector is y. Note that p(y, x) and p(y|x) are associated as p(y|x)=p(y, x)/p(x).

For example, the learning processing unit 150 updates the parameters to increase the simultaneous probability p(y, x) of input choices and output choices concerning each of the input and output sample vectors that indicate selection behavior for learning. In this case, the learning processing unit 150 updates the elements of the parameter vector θ in a gradient direction in which the simultaneous probability p(y, x) is probabilistically increased. That is, the learning processing unit 150 calculates a gradient with respect to the parameter vector θ of the simultaneous probability p(y, x) based on the selection model 10 shown in FIG. 7 and increases or decreases to update each of the elements of the parameter vector θ in the direction in which the simultaneous probability p(y, x) increases.

For example, the learning processing unit 150 updates the parameters to increase probabilities that output choices are selected according to the input choices (e.g., the conditional probability p(y|x)) concerning each kind of selection behavior for learning. In this case, the learning processing unit 150 updates the parameters in a gradient direction in which the conditional probability p(y|x) is probabilistically increased. That is, the learning processing unit 150 calculates a gradient with respect to the parameter vector θ of the conditional probability p(y|x) based on the selection model 10 shown in FIG. 7 and increases or decreases to update each of the elements of the parameter vector θ in the direction in which the conditional probability p(y|x) increases.

The simultaneous probability p(y, x) and the conditional probability p(y|x), based on the selection model 10 shown in FIG. 7, can be indicated using an energy function E(x, y, h; θ) and free energy F(x, y; θ), F(x; θ), and F(θ) indicated by the following expression. Here, a probability distribution of x having the parameter θ is represented as p(x; θ).

$$\begin{matrix}E ( \vec{x} , \vec{y} , \vec{h} , \vec{θ} ) = - {\sum }_{i = 1}^{J} {\sum }_{k = 1}^{K} {x}_{i} {W}_{ik} {h}_{k} - {\sum }_{j = 1}^{J} {\sum }_{k = 1}^{K} {y}_{j} {U}_{jk} {h}_{k} - {\sum }_{i = 1}^{J} {x}_{i} {b}_{i}^{x} - {\sum }_{j = 1}^{J} {y}_{j} {b}_{j}^{y} - {\sum }_{k = 1}^{K} {h}_{k} {b}_{k}^{h} & ( Expression 7 ) \\ \begin{matrix}F ( \vec{x} , \vec{y} ; \vec{θ} ) = {\sum }_{\vec{h}} p ( \vec{h} \vert \vec{x} , \vec{y} ; \vec{θ} ) E ( \vec{x} , \vec{y} , \vec{h} ; \vec{θ} ) + {\sum }_{\vec{h}} p ( \vec{h} \vert \vec{x} , \vec{y} ; \vec{θ} ) ln p ( \vec{h} \vert \vec{x} , \vec{y} ; \vec{θ} ) \\ F ( \vec{x} ; \vec{θ} ) = {\sum }_{\vec{y}} {\sum }_{\vec{h}} p ( \vec{y} , \vec{h} \vert \vec{x} ; \vec{θ} ) E ( \vec{x} , \vec{y} , \vec{h} ; \vec{θ} ) + {\sum }_{\vec{y}} {\sum }_{\vec{h}}^{ } p ( \vec{y} , \vec{h} \vert \vec{x} ; \vec{θ} ) ln p ( \vec{y} , \vec{h} \vert \vec{x} ; \vec{θ} ) \\ F ( \vec{θ} ) = {\sum }_{\vec{x}}^{ } {\sum }_{\vec{y}}^{ } {\sum }_{\vec{h}}^{ } p ( \vec{x} , \vec{y} , \vec{h} ; \vec{θ} ) E ( \vec{x} , \vec{y} , \vec{h} ; \vec{θ} ) + {\sum }_{\vec{x}}^{ } {\sum }_{\vec{y}}^{ } {\sum }_{\vec{h}}^{ } p ( \vec{x} , \vec{y} , \vec{h} ; \vec{θ} ) ln p ( \vec{x} , \vec{y} , \vec{h} ; \vec{θ} ) & \end{matrix} & ( Expression 8 )\end{matrix}$$

From Expression (7) and Expression (8), the simultaneous probability p(y, x) and the conditional probability p(y|x) are indicated by the following expression. In this way, a specific method of calculating the simultaneous probability p(y, x) and the conditional probability p(y|x) using the energy function and the free energy of the Boltzmann Machine on the basis of the selection model 10 is known.

$$\begin{matrix}p ( \vec{x} , \vec{y} ; \vec{θ} ) = \frac{{\sum }_{\vec{h}}^{ } exp \{ - E ( \vec{x} , \vec{y} , \vec{h} ; \vec{θ} ) \}}{{\sum }_{\tilde{\vec{x}}}^{ } {\sum }_{\tilde{\vec{y}}}^{ } {\sum }_{\tilde{\vec{h}}}^{ } exp \{ - E ( \tilde{\vec{x}} , \tilde{\vec{y}} , \tilde{\vec{h}} ; \vec{θ} ) \}} = \frac{exp \{ - F ( \vec{x} , \vec{y} ; \vec{θ} ) \}}{exp \{ - F ( \vec{θ} ) \}} & ( Expression 9 ) \\ p ( \vec{y} \vert \vec{x} ; \vec{θ} ) = \frac{{\sum }_{\vec{h}}^{ } exp \{ - E ( \vec{x} , \vec{y} , \vec{h} ; \vec{θ} ) \}}{{\sum }_{\tilde{\vec{y}}}^{ } {\sum }_{\tilde{\vec{h}}}^{ } exp \{ - E ( \vec{x} , \tilde{\vec{y}} , \tilde{\vec{h}} ; \vec{θ} ) \}} = \frac{exp \{ - F ( \vec{x} , \vec{y} ; \vec{θ} ) \}}{exp \{ - F ( \vec{x} ; \vec{θ} ) \}} & ( Expression 10 )\end{matrix}$$

The learning processing unit 150 calculates a gradient with respect to the parameter vector θ of the simultaneous probability p(y, x) from the following expression calculated from Expression (7) to Expression (9).

$$\frac{\partial }{\partial \vec{θ}} log p ( \vec{x} , \vec{y} ; \vec{θ} ) = {〈 \frac{\partial E ( \vec{x} , \vec{y} , \vec{h} ; \vec{θ} )}{\partial \vec{θ}} 〉}_{p ( \vec{h} \vert \vec{x} , \vec{y} ; \vec{θ} )} - { \sum }_{\vec{x}}^{ } p ( \vec{x} ; \vec{θ} ) {\sum }_{{\vec{y}}^{′} ∈ C ( \vec{x} )} p ( {\vec{y}}^{′} \vert \vec{x} ; \vec{θ} ) {〈 \frac{\partial E ( \vec{x} , {\vec{y}}^{′} , \vec{h} ; \vec{θ} )}{\partial \vec{θ}} 〉}_{p ( \vec{h} \vert \vec{x} , {\vec{y}}^{′} ; \vec{θ} )} \qquad ( Expression 11 )$$

Here, C(x) in Expression (11) is a set including a vector representing an element, which is 1 in the input vector x, using one-hot coding (a coding method of representation by a vector, one element of which is 1 and all the other elements of which are 0). The following expression is obtained by contriving weights in Expression (11) and transforming the expression. That is, an expected value can be taken for an item not included in an item set.

$$\frac{\partial }{\partial \vec{θ}} log p ( \vec{x} , \vec{y} ; \vec{θ} ) = {〈 \frac{\partial E ( \vec{x} , \vec{y} , \vec{h} ; \vec{θ} )}{\partial \vec{θ}} 〉}_{p ( \vec{h} \vert \vec{x} , \vec{y} ; \vec{θ} )} - { \sum }_{\vec{x}}^{ } p ( \vec{x} ; \vec{θ} ) {\sum }_{{\vec{y}}^{′}} p ( {\vec{y}}^{′} \vert \vec{x} ; \vec{θ} ) {〈 \frac{\partial E ( \vec{x} , {\vec{y}}^{′} , \vec{h} ; \vec{θ} )}{\partial \vec{θ}} 〉}_{p ( \vec{h} \vert \vec{x} , {\vec{y}}^{′} ; \vec{θ} )} \qquad ( Expression 12 )$$

The learning processing unit 150 updates the parameter vector θ for each of the input and output sample vectors from a predetermined initial value using Expression (11) or Expression (12). As an example, the learning processing unit 150 increases the elements of the parameter vector θ of the initial value by predetermined values (ΔW, ΔU, Δb^{x}, Δb^{h}, and Δb^{y}) in an increasing (plus) direction of the gradient of Expression (11) in which the initial value is substituted. For example, the learning processing unit 150 repeats the update until the increase or the decrease of the simultaneous probability p(y, x) converges within a predetermined range. Alternatively, the learning processing unit 150 may repeat the update a predetermined number of times.

The learning processing unit 150 may repeat the update of the parameter vector θ from a plurality of initial values respectively. In this case, as an example, the learning processing unit 150 repeats the update until each of the elements of the parameter vector θ converges within a predetermined range. Consequently, the learning processing unit 150 can set the parameter vector θ having higher accuracy.

The learning processing unit 150 may change the initial value, for example, when the increase or decrease of the simultaneous probability p(y, x) does not converge or when a part or all of the elements of the parameter vector θ do not converge. A specific method of calculating a gradient of the simultaneous probability p(y, x) and updating the parameters in a gradient direction to increase the simultaneous probability p(y, x) in this way is known as “Gradient for generative training”.

Similarly, the learning processing unit 150 calculates a gradient with respect to the parameter vector θ of the conditional probability p(y|x) from the following expression calculated from Expression (7), Expression (8), and Expression (10):

$$\frac{\partial }{\partial \vec{θ}} log p ( \vec{y} \vert \vec{x} ; \vec{θ} ) = {〈 \frac{\partial E ( \vec{x} , \vec{y} , \vec{h} ; \vec{θ} )}{\partial \vec{θ}} 〉}_{p ( \vec{h} \vert \vec{x} , \vec{y} ; \vec{θ} )} - {\sum }_{{\vec{y}}^{′} ∈ C ( \vec{x} )} p ( {\vec{y}}^{′} \vert \vec{x} ; \vec{θ} ) {〈 \frac{\partial E ( \vec{x} , {\vec{y}}^{′} , \vec{h} ; \vec{θ} )}{\partial \vec{θ}} 〉}_{p ( \vec{h} \vert \vec{x} , {\vec{y}}^{′} ; \vec{θ} )} \qquad ( Expression 13 )$$

In Expression (13), as in Expression (11), the following expression is obtained by contriving weights and transforming the expression.

$$\frac{\partial }{\partial \vec{θ}} log p ( \vec{y} \vert \vec{x} ; \vec{θ} ) = {〈 \frac{\partial E ( \vec{x} , \vec{y} , \vec{h} ; \vec{θ} )}{\partial \vec{θ}} 〉}_{p ( \vec{h} \vert \vec{x} , \vec{y} ; \vec{θ} )} - {\sum }_{{\vec{y}}^{′}} p ( {\vec{y}}^{′} \vert \vec{x} ; \vec{θ} ) {〈 \frac{\partial E ( \vec{x} , {\vec{y}}^{′} , \vec{h} ; \vec{θ} )}{\partial \vec{θ}} 〉}_{p ( \vec{h} \vert \vec{x} , {\vec{y}}^{′} ; \vec{θ} )} \qquad ( Expression 14 )$$

As in the case of the simultaneous probability p(y, x), the learning processing unit 150 updates the parameter vector θ for each of the input and output sample vectors from a predetermined initial value using Expression (13) or Expression (14) and sets the parameter vector θ. A specific method of calculating a gradient of the conditional probability p(y|x) and updating the parameters in a gradient direction to increase the conditional probability p(y|x) in this way is known as “Gradient for discriminative training”.

In the above explanation, the learning processing unit 150 in this embodiment calculates a gradient of the simultaneous probability p(y, x) or the conditional probability p(y|x) and updates the parameter in a gradient direction. Instead, the learning processing unit 150 may calculate gradients of the simultaneous probability p(y, x) and the conditional probability p(y|x) respectively and update the parameters on the basis of the calculated two gradients. That is, as an example, after calculating gradients of the simultaneous probability p(x, y) and the conditional probability p(x|y) from Expression (11) and Expression (12) respectively, the learning processing unit 150 further calculates a combined (hybrid) gradient of the two gradients as indicated by the following expression:

r log p(\vec{x}, \vec{y}; \vec{θ})+(1−r)log p(\vec{y}|\vec{x}; \vec{θ}) (Expression 15)

As in the case of the simultaneous probability p(y, x) and the like, the learning processing unit 150 updates the parameter vector θ for each of the input and output sample vectors from the predetermined initial value using Expression (13) and sets the parameter vector θ. A specific method of calculating a combination of gradients of the simultaneous probability p(y, x) and the conditional probability p(y|x) and updating the parameters in a gradient direction of the combination to increase the simultaneous probability p(y, x) and the conditional probability p(y|x) in this way is known as “Gradient for hybrid training”.

As explained above, the learning processing unit 150 in this embodiment can learn, on the basis of the Restricted Boltzmann Machine, the selection model 10 obtained by modeling the cognitively-biased selection behavior of the consumer. The learning processing unit 150 can learn the selection model 10 according to a known learning algorithm without using a complicated and special algorithm. The learning processing unit 150 stores the parameter vector θ of the learned selection model 10 in the storing unit 120.

The probability calculating unit 160 calculates, on the basis of the parameters including the first weight values, the second weight values, the input biases, the intermediate biases, and the output biases, probabilities that the respective choices are selected according to input choices (S240). The probability calculating unit 160 may read out the parameter vector θ of the selection model 10 learned from the storing unit 120 and calculate the probabilities that the choices are selected. The probability calculating unit 160 may calculate, using Expression (9) and Expression (10), the probability that the choices are selected.

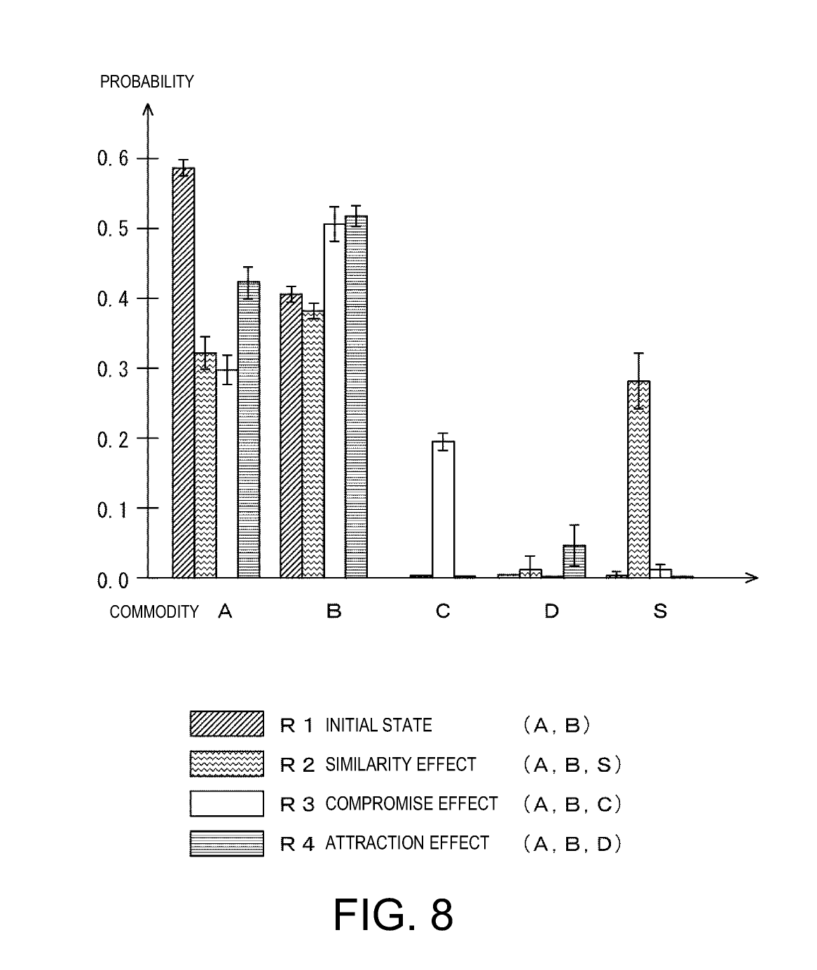

FIG. 8 illustrates an example of the probabilities that the choices calculated by the probability calculating unit 160 according to this embodiment are selected. FIG. 8 is an example of a result obtained by learning the selection model 10 targeting the learning data shown in FIG. 6. That is, contents respectively indicated by the abscissa, the ordinate, and bar graphs in FIG. 8 are substantially the same as the contents shown in FIG. 6.

By comparing FIG. 8 and FIG. 6, it is illustrated that the processing apparatus 100 in this embodiment can calculate a probability having tendency substantially the same as the tendency of the target learning data. It is also illustrated that a change in the ratio of the selection probabilities of the commodity A and the commodity B in the initial state according to choices presented to the consumer can be reproduced. Consequently, it can be confirmed that the processing apparatus 100 can represent consumption behavior of the consumer cognitively biased by the similarity effect, the compromise effect, the attraction effect, and the like using the selection model 10 and can learn the selection model 10 using the known learning algorithm.

In the above explanation, in the processing apparatus 100 in this embodiment, the learning processing unit 150 analytically calculates the conditional probability p(y|x) on the basis of the Restricted Boltzmann Machine and learns the selection model 10. Alternatively, the learning processing unit 150 may estimate the conditional probability p(y|x) using Gibbs sampling or the like and learn the selection model 10.

In this case, the learning processing unit 150 can estimate, according to presentation of L commodities, by executing the Gibbs sampling on the output vector of the output layer 14 and the intermediate node of the intermediate layer 16 while fixing the input vector of the input layer 12, probabilities that the respective commodities are selected by the consumer. In this case, as an example, the learning processing unit 150 can determine the parameter vector θ using a gradient method or the like such that the conditional probability p(y|x) to be estimated is maximized and learn the selection model 10.

As explained above, the processing apparatus 100 in this embodiment can learn the selection model 10 and represent cognitively-biased consumption behavior of the consumers. Consequently, for example, when the acquiring unit 110 acquires learning data including, as selection behavior for learning, choices selected by the user with respect to choices of commodities or services given to the user, the learning processing unit 150 can learn the selection model 10 obtained by modeling the selection behavior of the user corresponding to the commodities or the services. In this case, a target is the user and choices are the choices of the commodities or the services given to the user. Consequently, the processing apparatus 100 can learn purchase behavior of the user.

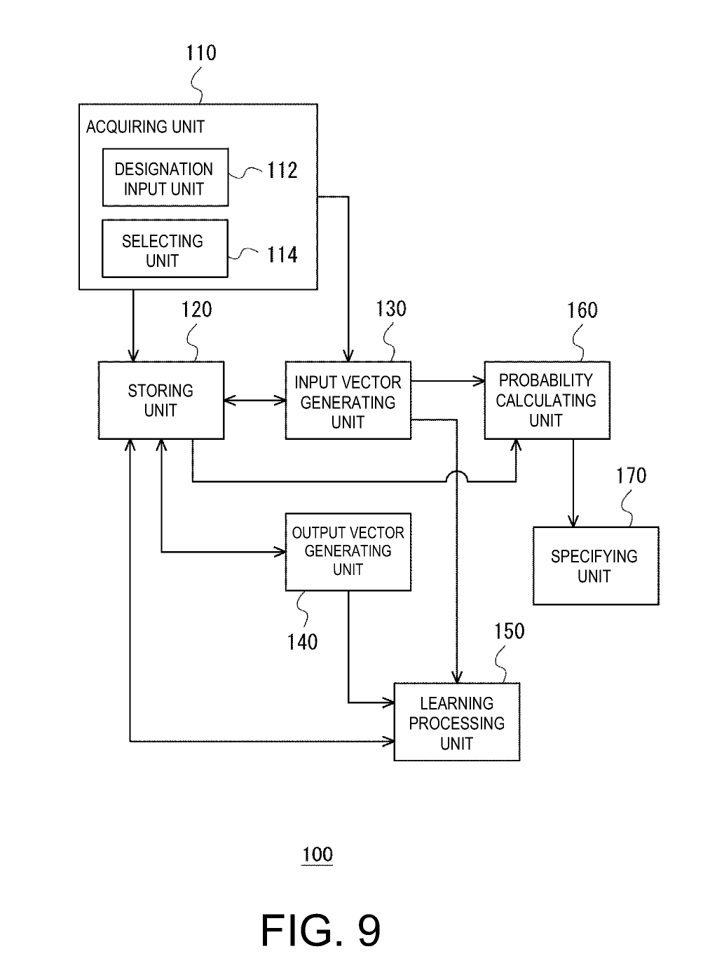

FIG. 9 illustrates a first modification of the processing apparatus 100 according to an illustrative embodiment. In the processing apparatus 100 in this modification, units that perform operations substantially the same operations of the units of the processing apparatus 100 according to this embodiment shown in FIG. 4 are denoted by the same reference numerals and explanation of the units is omitted. The acquiring unit 110 of the processing apparatus 100 in this modification includes a designation input unit 112 and a selecting unit 114. The processing apparatus 100 in this modification further includes a specifying unit 170.

The designation input unit 112 receives designation of a commodity or a service promoted for sale among a plurality of kinds of commodities or services. As an example, the designation input unit 112 receives, from the user, designation of a commodity, a service, or the like that the user desires to sell.

The selecting unit 114 selects, out of a plurality of kinds of choices corresponding to the plurality of kinds of commodities or services, a plurality of input choices including, as a choice, a commodity or a service to be promoted for sale. For example, when the user inputs designation of the commodity B to the designation input unit 112 as a commodity to be promoted for sale, the selecting unit 114 selects a plurality of choices (A, B), (A, B, and C), and the like including the commodity B. The selecting unit 114 supplies information concerning the plurality of choices selected in this way to the input vector generating unit 130.

As explained above, the input vector generating unit 130 generates a plurality of input vectors corresponding to the received choices and supplies the input vectors to the probability calculating unit 160. As explained above, the probability calculating unit 160 reads out the parameter vector θ of the learned selection model 10 and calculates probabilities that the choices are selected.

The specifying unit 170 specifies, among the plurality of input choices, an input choice with which a probability that a choice corresponding to the commodity or the service promoted for sale is selected is higher. As an example, according to the result in FIG. 8, the specifying unit 170 specifies the choice R4 (the commodities A, B, and D) as the choice with which a probability that the commodity B is selected is higher. In this way, the processing apparatus 100 in this modification can appropriately specify, according to a commodity or the like desired to be promoted for sale, a choice that should be presented to the user.

In the processing apparatus 100 in this embodiment explained above, the acquiring unit 110 may acquire learning data including a choice selected by the user out of choices presented on a web site. That is, in this example, a target is the user and choices are presented to the user on the web site. Consequently, the processing apparatus 100 can model, for example, selection behavior of a consumer who performs shopping via the Internet. The processing apparatus 100 can learn purchase behavior of the consumer and present an appropriate choice including a commodity or the like promoted for sale to the consumer via the web site.

The processing apparatus 100 in this embodiment can calculate, according to a choice presented to the consumer, probabilities that respective commodities included in the choice are selected. Therefore, the processing apparatus 100 can also calculate, according to a menu presented to the consumer by an eating place such as a cafeteria or a restaurant, probabilities that menu items included in the menu are selected. Consequently, the processing apparatus 100 can predict the numbers, the materials, and the like of menu items that should be prepared according to a menu presented by the eating place or the like.

In the above explanation of the processing apparatus 100 in this embodiment, the learning processing unit 150 generates and learns one selection model 10. Alternatively, the learning processing unit 150 may generate and separately and independently learn each of a plurality of the selection models 10. The learning processing unit 150 generates the plurality of selection models 10 in association with a plurality of consumer groups and learns the selection model 10 for each of the consumer groups. The consumer group is a group including one or more consumers. Consequently, it is possible to more finely analyze, for each of consumers, selection behavior of the consumer.

The processing apparatus 100 in this embodiment can learn the selection model 10 that can represent cognitively-biased consumption behavior of the consumer. However, selection probabilities of commodities are calculated using the learned selection model 10, a selection probability having a nonzero value is also calculated for a commodity not included in choices. For example, in the probabilities that the choices calculated by the probability calculating unit 160 are selected shown in FIG. 8, nonzero selection probabilities are respectively calculated for the commodities A, B, and S corresponding to the choice R2. However, the probability calculating unit 160 outputs, even for the commodity D not included in the choice R2, a nonzero selection probability as a calculation result.

Similarly, the probability calculating unit 160 calculates nonzero selection probabilities respectively for the commodities A, B, and C corresponding to the choice R3 and, even for the commodity S not included in the choice R3, outputs a nonzero selection probability as a calculation result. In this way, all selection probabilities calculated for commodities not presented to the consumer are errors.

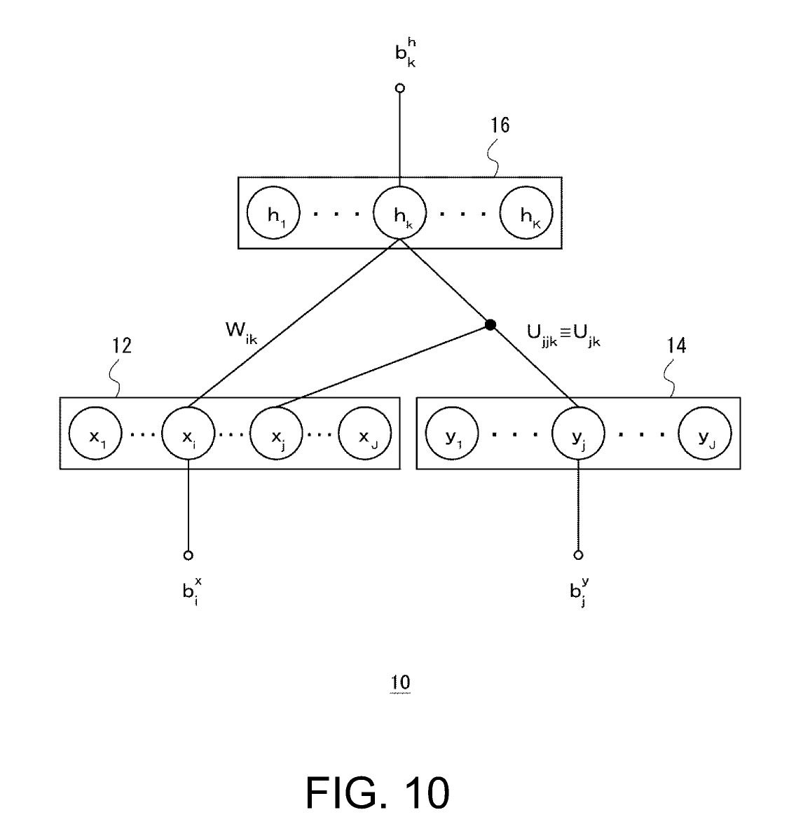

In this embodiment, an example is explained in which the selection model 10, explained with reference to FIG. 7, reduces such errors. FIG. 10 illustrates a modification of the selection model 10 according to this embodiment. In the selection model 10 in this modification, sections that perform operations substantially the same as the operations of the sections of the selection model according to this embodiment shown in FIG. 7 are denoted by the same reference numerals and signs and explanation of the operations is omitted.

In the selection model 10 in this modification, the first weight values Wᵢₖ of the symmetrical weight are set between the input nodes xᵢ and the intermediate nodes hₖ. In the selection model 10, second weight values Uⱼⱼₖ are set among the input nodes xⱼ, the intermediate nodes hₖ, and the output nodes yⱼ. That is, the second weight values Uⱼⱼₖ are three-direction weights, weight values of which are set according to values of the input nodes xⱼ, the intermediate nodes hₖ, and the output nodes yⱼ.

As the second weight values Uⱼⱼₖ, when a value of the input node xⱼ is 1 (in the case of a commodity presented to the user), a weight value of the output node yⱼ corresponding to the input node xⱼ is set to the second weight value Uⱼₖ explained with reference to FIG. 7. Weight values of nodes other than the corresponding output node yⱼ are set to values smaller than 1. As the second weight values Uⱼⱼₖ, as an example, weight values of nodes other than the corresponding output nodes yⱼ are set to 0. In this case, the second weight values Uⱼⱼₖ are indicated by the following expression:

Uᵢⱼₖ=Uⱼₖδᵢⱼ (Expression 16)

Here, δᵢⱼ is a function known as Kronecker delta, which is 1 when i and j are equal (i=j) and is 0 when i and j are different (i≠j). In this way, in the selection model 10 in this embodiment, a gating function is added to the second weight values to reduce a selection probability of a commodity not presented to the consumer and absent as a choice.

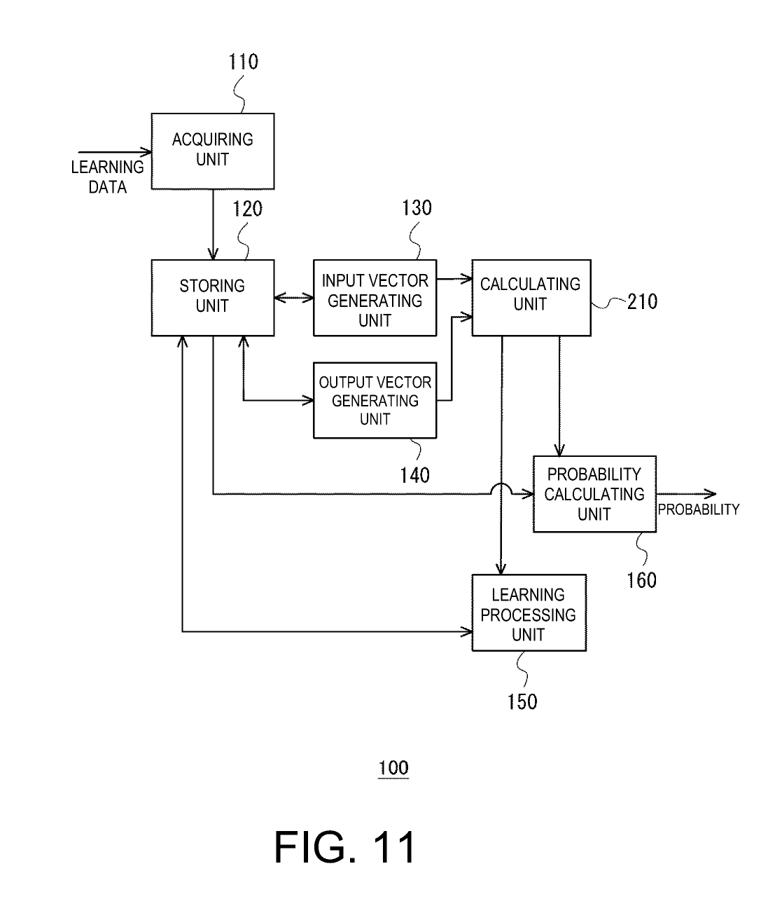

An example is explained in which the processing apparatus 100, explained with reference to FIG. 4, learns the first weight values Wᵢₖ and the second weight values Uⱼⱼₖ of the selection model 10 in this modification. FIG. 11 illustrates a second modification of the processing apparatus 100 according to this embodiment. In the processing apparatus 100 in this modification, units that perform operations substantially the same operations of the units of the processing apparatus 100 according to this embodiment shown in FIG. 4 are denoted by the same reference numerals and explanation of the units is omitted.

That is, the processing apparatus 100 in this modification processes the selection model 10 including the input layer 12 including the plurality of input nodes shown in FIG. 10, the output layer 14 including the plurality of output nodes, and the intermediate layer 16 including the plurality of intermediate nodes. The processing apparatus 100 in this modification includes a calculating unit 210.

The acquiring unit 110 acquires a plurality of input values to the plurality of input nodes xᵢ. The acquiring unit 110 may acquire learning data including a plurality of input values and a plurality of output values that should be output to a plurality of output nodes to correspond to the plurality of input values.

The input vector generating unit 130 generates the input vector x indicating whether each of a plurality of kinds of choices is included in input choices. The output vector generating unit 140 generates the output vector y indicating whether each of the plurality of kinds of choices is included in output choices for learning.

The calculating unit 210 is connected to the input vector generating unit 130 and the output vector generating unit 140 and receives information such as an input vector and an output vector. The calculating unit 210 calculates a plurality of output values from a plurality of output nodes corresponding to a plurality of input values using the selection model 10 in which the influence of a second weight value set between the output node and the intermediate node corresponding to the input node whose input value is 0 is reduced.

In the calculation of the plurality of output values from the plurality of output nodes corresponding to the plurality of input values, the calculating unit 210 may reduce the influence of a second weight value obtained by multiplying an output value of the output node corresponding to the input node whose input value is 0, with a coefficient smaller than 1. As an example, in the calculation of the plurality of output values from the plurality of output nodes corresponding to the plurality of input values, the calculating unit 210 multiplies the output value of the output node corresponding to the input node whose input value is 0, with a coefficient 0 to set the output value to 0.

For example, the calculating unit 210 reduces the magnitude of a second weight value Uᵢⱼₖ set between the output node yᵢ (i≠j) not corresponding to the input node xⱼ whose input value is 1, and the intermediate node hₖ without changing the second weight value Uⱼⱼₖ set between the output node yⱼ corresponding to the input node xⱼ whose input value is 1, and the intermediate node hₖ. The calculating unit 210 may reduce the magnitude of the second weight value Uᵢⱼₖ to a value smaller than 1.

As an example, the calculating unit 210 sets the magnitude of the second weight value Uᵢⱼₖ set between the output node yᵢ not corresponding to the input node xⱼ whose input value is 1, and the intermediate node hₖ to 0. The calculating unit 210 calculates, on the basis of the second weight value after the reduction, a plurality of output values from the plurality of output nodes corresponding to the plurality of input values. As an example, the calculating unit 210 calculates an output value yⱼ^{out} of the output node yⱼ as indicated by the following expression:

yⱼ^{out}=xᵢyⱼUᵢⱼₖ=xᵢyⱼUⱼₖδᵢⱼ (Expression 17)

The calculating unit 210 supplies information such as the input vector, the output vector, the first weight values, and the second weight values to the learning processing unit 150. The calculating unit 210 may be connected to the storing unit 120. In this case, the calculating unit 210 supplies the set first weight values and second weight values to the storing unit 120. In this case, the storing unit 120 stores the first weight values set among the nodes between the input layer 12 and the intermediate layer 16 and the second weight values set among the nodes between the intermediate layer 16 and the output layer 14.

The learning processing unit 150 is connected to the calculating unit 210 and learns the selection model 10 in this modification on the basis of a plurality of input values and a plurality of output values for learning. That is, the learning processing unit 150 learns the selection model 10 in this modification including selection behavior corresponding to a cognitive bias of a target. As an example, the learning processing unit 150 learns the selection model 10 in this modification on the basis of the plurality of input vectors x and the plurality of output vectors y indicated by Expression (2) and Expression (4) according to the learning method explained above.

That is, the learning processing unit 150 sets a second weight value set between an output node and an intermediate node corresponding to an input node, an input value for learning of which is 0, to 0 and learns the selection model 10 in this modification. In this case, the learning processing unit 150 may use, instead of the energy function of Expression (7), as an example, the following expression reflecting the selection model 10 shown in FIG. 10:

$$E ( \vec{x} , \vec{y} , \vec{h} ; \vec{θ} ) = - {\sum }_{i = 1}^{J} {\sum }_{k = 1}^{K} {x}_{i} {h}_{k} {W}_{ik} - {\sum }_{i = 1}^{J} {\sum }_{j = 1}^{J} {\sum }_{k = 1}^{K} {x}_{i} {y}_{j} {h}_{k} {U}_{jk} - {\sum }_{i = 1}^{J} {x}_{i} {b}_{i}^{x} - {\sum }_{j = 1}^{J} {y}_{j} {b}_{j}^{y} - {\sum }_{k = 1}^{K} {h}_{k} {b}_{k}^{h} \qquad ( Expression 18 )$$

When a suffix y is defined as indicated by the following expression, Expression (18) can be represented like Expression (20):

$$\begin{matrix} y ∈ \{ 1 , 2 , … , J \} y {=}^{△} ( {δ}_{y 1} , {δ}_{y 2} , … , {δ}_{yJ} ) & ( Expression 19 ) \\ E ( \vec{x} , \vec{y} , \vec{h} ; \vec{θ} ) = - {\sum }_{i = 1}^{J} {\sum }_{k = 1}^{K} {x}_{i} {h}_{k} {W}_{ik} - {\sum }_{k = 1}^{K} {x}_{y} {h}_{k} {U}_{yk} - {\sum }_{i = 1}^{J} {x}_{i} {b}_{i}^{x} - {x}_{y} {b}_{y}^{y} - {\sum }_{k = 1}^{K} {h}_{k} {b}_{k}^{h} & ( Expression 20 )\end{matrix}$$

By using an energy function of Expression (20) and the free energy F(x, y; θ) and F(x; θ) of Expression (8), the conditional probability p(y|x) can be calculated as indicated by Expression (10). Therefore, the learning processing unit 150 calculates a gradient with respect to the parameter vector θ from Expression (13) in the conditional probability p(y|x) based on the energy function of Expression (20) and updates the parameters in a gradient direction in which the conditional probability p(y|x) is probabilistically increased.

As explained above, the learning processing unit 150 in this modification can learn the selection model 10 shown in FIG. 10 as explained concerning the learning of the selection model 10 shown in FIG. 7. Note that, in the selection model 10 shown in FIG. 10, the vectors x and y cannot be simultaneously set even if the vector h is given. Therefore, the “Gradient for generative training” of the simultaneous probability p(y, x) cannot be executed.

As explained above, the learning processing unit 150 in this modification can learn, on the basis of the Restricted Boltzmann Machine, the selection model 10 shown in FIG. 10 obtained by modeling cognitively-biased selection behavior of the consumer. The probability calculating unit 160 according to this modification can calculate probabilities that choices are selected on the basis of the learned selection model 10.

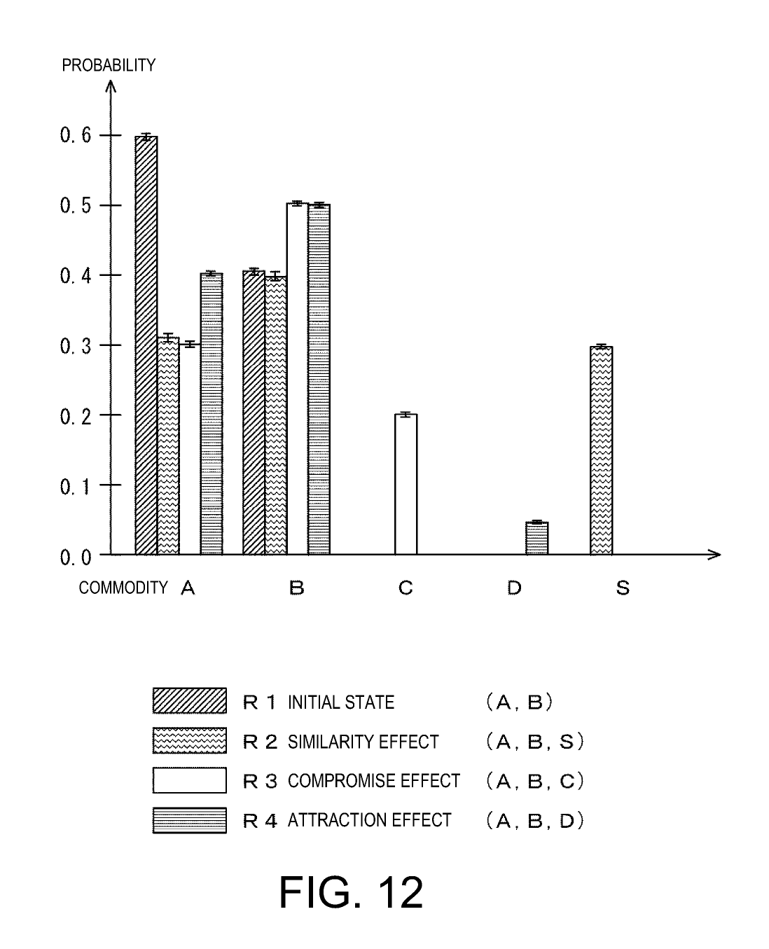

FIG. 12 illustrates an example of probabilities that the choices calculated by the probability calculating unit 160 according to this modification are selected. Like FIG. 8, FIG. 12 is an example of a result obtained by learning the selection model 10 shown in FIG. 10 targeting the learning data shown in FIG. 6. That is, contents respectively indicated by the abscissa, the ordinate, and bar graphs in FIG. 12 are substantially the same as the contents shown in FIG. 6 and FIG. 8.

By comparing FIG. 12 and FIG. 6, it is seen that the processing apparatus 100 in this modification can calculate a probability having a tendency substantially the same as the target learning data. It is also seen that a change in the ratio of the selection probabilities of the commodity A and the commodity B in the initial state according to choices presented to the consumer can be reproduced. Consequently, it is seen that the learning processing unit 150 in this modification can learn the selection model 10 in this modification in which a ratio of selection probabilities of choices included in input choices is variable depending on a combination of the other choices included in the input choices.

By comparing FIG. 12 and FIG. 8, it is seen that the processing apparatus 100 in this modification calculates substantially 0 as selection probabilities for commodities not included in a choice. For example, in the probabilities that the choices are selected shown in FIG. 12, nonzero selection probabilities are calculated for the commodities A, B, and S corresponding to the choice R2 and a substantially zero selection probability is obtained as a calculation result for the commodity D not included in the choice R2.

Similarly, nonzero selection probabilities are calculated for the commodities A, B, and C corresponding to the choice R3 and a substantially zero selection probability is obtained as a calculation result for the commodity S not included in the choice R3. In this way, the processing apparatus 100 in this modification can reduce selection probabilities calculated for commodities not presented to the consumer to substantially 0 and reduce errors of the selection probabilities.

In the above explanation, the processing apparatus 100 in this modification reduces errors of selection probability using the selection model 10 in which the influence of the second weight value set between the output node and the intermediate node corresponding to the input node whose input value is 0 is reduced. The processing apparatus 100 may use a model for reducing the influence of the second weight value when the input node has a value equal to or smaller than a predetermined threshold instead of when the input node xᵢ of the selection model 10 is 0. In this case, the processing apparatus 100 may calculate a plurality of output values from a plurality of output nodes corresponding to a plurality of input values to be equal to or smaller than the threshold.

In the above explanation, the processing apparatus 100 in this embodiment uses the selection model 10 obtained by modeling the selection behavior of the target with respect to the given choices. However, the processing apparatus 100 is not limited to this and may use a prediction model for predicting a probability distribution. For example, the processing apparatus 100 can select any m sub-sets B from a population A (a discrete set A) of size A and apply the sub-sets B to a prediction model based on the Restricted Boltzmann Machine for predicting a probability distribution defined by the sub-sets B. That is, when the processing apparatus 100 learns the prediction model and calculates the probability distribution defined by the sub-sets B, the processing apparatus 100 can set a probability distribution of the population A not included in the sub-sets B to substantially 0. Therefore, it is possible to efficiently learn and accurately calculate the probability distribution.

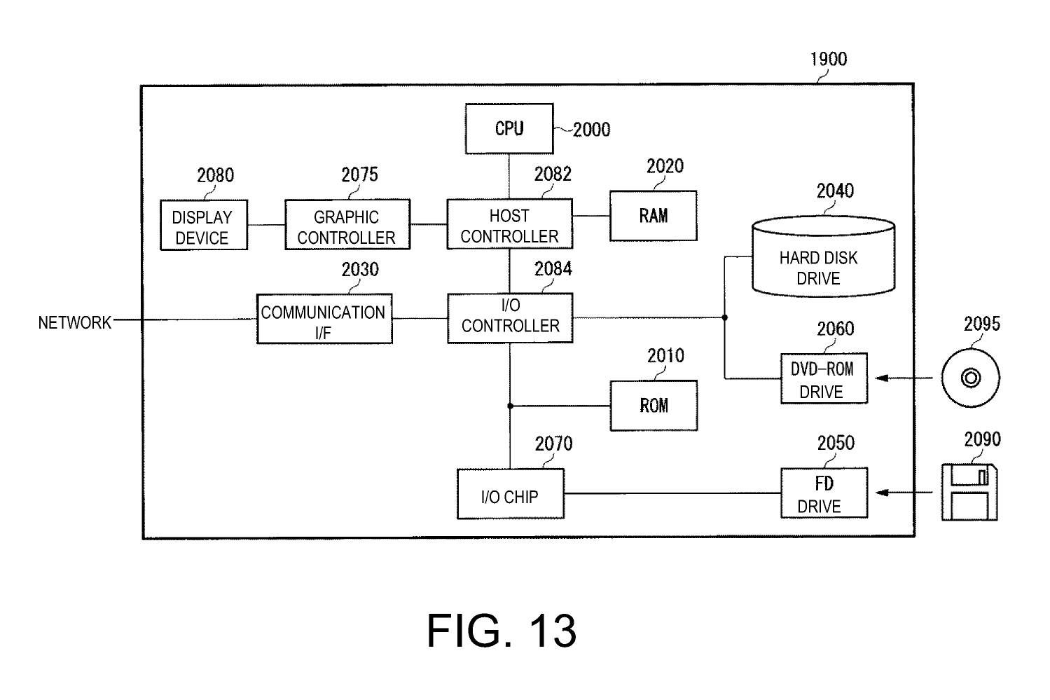

FIG. 13 illustrates an example of a hardware configuration of a computer 1900 functioning as the processing apparatus 100 according to an illustrative embodiment. The computer 1900 according to this embodiment includes a CPU peripheral unit including a CPU 2000, a RAM 2020, a graphic controller 2075, and a display device 2080 connected to one another by a host controller 2082, an input-output unit including a communication interface 2030, a hard disk drive 2040, and a DVD drive 2060 connected to the host controller 2082 by the input-output controller 2084, and a legacy input-output unit including a ROM 2010, a flexible disk drive 2050, and an input-output chip 2070 connected to the input-output controller 2084.

The host controller 2082 connects the RAM 2020 and the CPU 2000 and the graphic controller 2075 that access the RAM 2020 at a high transfer rate. The CPU 2000 operates and performs control of the units on the basis of programs stored in the ROM 2010 and the RAM 2020. The graphic controller 2075 acquires image data generated by the CPU 2000 or the like on a frame buffer provided in the RAM 2020 and causes the display device 2080 to display the image data. Alternatively, the graphic controller 2075 may include, on the inside, a frame buffer that stores the image data generated by the CPU 2000 or the like.

The input-output controller 2084 connects the host controller 2082, the communication interface 2030, which is a relatively high-speed input-output device, the hard disk drive 2040, and the DVD drive 2060. The communication interface 2030 communicates with other apparatuses via a network. The hard disk drive 2040 stores a program and data used by the CPU 2000 in the computer 1900. The DVD drive 2060 reads a program or data from a DVD-ROM 2095 and provides the hard disk drive 2040 with the program or the data via the RAM 2020.

The ROM 2010 and a relatively low-speed input-output device for the flexible disk drive 2050 and the input-output chip 2070 are connected to the input-output controller 2084. The ROM 2010 stores, for example, a boot program executed by the computer 1900 during startup and/or a program that depends on hardware of the computer 1900. The flexible disk drive 2050 reads a program or data from a flexible disk 2090 and provides the hard disk drive 2040 with the program or the data via the RAM 2020. The input-output chip 2070 connects the flexible disk drive 2050 to the input-output controller 2084 and connects various input-output devices to the input-output controller 2084 via, for example, a parallel port, a serial port, a keyboard port, or a mouse port.

The program provided to the hard disk drive 2040 via the RAM 2020 is stored in the flexible disk 2090, the DVD-ROM 2095, or a recording medium such as an IC card and provided by a user. The program is read out from the recording medium, installed in the hard disk drive 2040 in the computer 1900 via the RAM 2020, and executed in the CPU 2000.

The program is installed in the computer 1900 and causes the computer 1900 to function as the acquiring unit 110, the storing unit 120, the input vector generating unit 130, the output vector generating unit 140, the learning processing unit 150, the probability calculating unit 160, the specifying unit 170, the calculating unit 210, and the like.

Information processing described in the program is read by the computer 1900 to thereby function as the acquiring unit 110, the storing unit 120, the input vector generating unit 130, the output vector generating unit 140, the learning processing unit 150, the probability calculating unit 160, the specifying unit 170, the calculating unit 210, and the like, which are specific means obtained by software and the various hardware resources explained above cooperating with each other. An operation or processing of information corresponding to a purpose of use of the computer 1900 in this embodiment is realized by the specific means, whereby a peculiar processing apparatus 100 corresponding to the purpose of use is built.

As an example, when communication is performed between the computer 1900 and an external apparatus or the like, the CPU 2000 executes a communication program loaded on the RAM 2020 and instructs, on the basis of processing contents described in the communication program, the communication interface 2030 to perform communication processing. The communication interface 2030 is controlled by the CPU 2000 and reads out transmission data stored in a transmission buffer regions or the like provided on a storage device such as the RAM 2020, the hard disk drive 2040, the flexible disk 2090, or the DVD-ROM 2095 and transmits the transmission data to the network or writes reception data received from the network in a reception buffer region or the like provided on the storage device. In this way, the communication interface 2030 may transfer the transmission and reception data between the communication interface 2030 and the storage device according to a DMA (direct memory access) system. Alternatively, the CPU 2000 may read out data from the storage device or the communication interface 2030 at a transfer source and write the data in the communication interface 2030 or the storage device at a transfer destination to thereby transfer the transmission and reception data.

The CPU 2000 reads all parts or a necessary part out of a file, a database, or the like stored in an external storage device such as the hard disk drive 2040, the DVD drive 2060 (the DVD-ROM 2095), or the flexible disk drive 2050 (the flexible disk 2090) into the RAM 2020 according to DMA transfer or the like and applies various kinds of processing to data on the RAM 2020. The CPU 2000 writes back the data subjected to the processing to the external storage device according to the DMA transfer or the like. In such processing, the RAM 2020 can be regarded as temporarily retaining contents of the external storage device. Therefore, in this embodiment, the RAM 2020, the external storage device, and the like are generally referred to as memory, storing unit, storage device, or the like. Various kinds of information concerning various programs, data, tables, databases, and the like in this embodiment are stored on such a storage device and subjected to information processing. The CPU 2000 can retain a part of the RAM 2020 in a cache memory and perform reading and writing on the cache memory. In such a form, the cache memory performs a part of the function of the RAM 2020. Therefore, except when being distinguished, the cache memory is also included in the RAM 2020, the memory, and/or the storage device.

The CPU 2000 applies various kinds of processing including the various kinds of operations, processing of information, condition determination, and search and replacement of information described in this embodiment designated by a command sequence of the program to the data read out from the RAM 2020 and writes back the data to the RAM 2020. For example, in performing the condition determination, the CPU 2000 determines whether the various variables described in this embodiment satisfy a condition that the variables are, for example, larger than, smaller than, equal to or larger than, equal to or smaller than, or equal to other variables or constants and, when the condition is satisfied (or not satisfied), branches to a different command sequence or invokes a sub-routine.

The CPU 2000 can search for information stored in a file, a database, or the like in the storage device. For example, when a plurality of entries, in which attribute values of a second attribute are respectively associated with attribute values of a first attribute, are stored in the storage device, the CPU 2000 can obtain the attribute value of the second attribute associated with the first attribute satisfying a predetermined condition by searching for an entry, in which the attribute value of the first attribute coincides with a designated condition, out of the plurality of entries stored in the storage device and reading out the attribute value of the second attribute stored in the entry.

The program or the module explained above may be stored in an external recording medium. As the recording medium, besides the flexible disk 2090 and the DVD-ROM 2095, an optical recording medium such as a DVD, a Blu-ray (registered trademark), or a CD, a magneto-optical recording medium such as an MO, a tape medium, a semiconductor memory such as an IC card, and the like can be used. A storage device such as a hard disk or a RAM provided in a server system connected to a dedicated communication network or the Internet may be used as a recording medium to provide the program to the computer 1900 via the network.

The present invention is explained above with reference to the embodiment. However, the technical scope of the present invention is not limited to the scope described in the embodiment. It is evident for those skilled in the art that various changes or improvements can be added to the embodiment. It is evident from the description of the scope of claims that forms added with such changes or improvements could be included in the technical scope of the present invention.

It should be noted that the execution order of the process steps, such as the operations, procedures, steps, and stages in the apparatus, system, program, and the method explained in the claims, specification, and drawings could be realized in any order unless the execution order is clearly indicated as “before”, “prior to”, or the like in particular and an output of preceding process steps is used in later processing. Even if an operation flow is described in the claims, specification, and drawings using “first”, “subsequently”, and the like for convenience, this does not mean that it is essential to carry out the operation flow in the described order.

1. A processing method for generating a selection model obtained by modeling selection behavior of a target to a given choice, the processing method comprising:
acquiring learning data, using a hardware processor, including at least one selection behavior for learning in which choices given to the target are input choices and choices selected out of the input choices are output choices;
generating an input vector that indicates whether each of a plurality of kinds of choices is included in the input choices; and
learning the selection model using the input vector corresponding to an input choice for learning and the output choices.
